(19) United States
(12) Patent Application Publication
(10) Pub. No.: US 2010/0162223 A1
(43) Pub. Date: Jun. 24, 2010

(54) Control device, disk array device, and control method

(75) Inventors: Kenji Hattori, Kawasaki (JP); Jun Ishikawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/588,920

(22) Filed: Nov. 2, 2009

(30) Foreign Application Priority Data
Dec. 24, 2008 (JP) 2008-327884

(51) Int. Cl. G06F 9/44; G06F 12/00

(52) U.S. Cl. 717/168; 711/114; 711/E12.001

(57) ABSTRACT

A control device is provided. The control device for updating firmware includes a transfer unit, a judgment unit, a switching control unit and an update unit. The transfer unit transfers data to a first device or a second device by using a path that can switch a transferring destination of data to the first device or the second device. The judgment unit judges whether processing the data by firmware controlling the first device is completed, the data transferred to the first device by the transfer unit. The switching control unit switches the transferring destination of data to the second device in the transfer unit when the judgment unit judges that processing of the data is completed. The update unit updates the firmware controlling the first device after the switching control unit switches the transferring destination of data to the second device in the transfer unit.

### CROSS-REFERENCE TO RELATED APPLICATIONS

This application is related to and claims priority to Japanese Patent Application No. 2008-327884, filed on Dec. 24, 2008, and incorporated herein by reference.

### BACKGROUND

1. Field

The embodiments discussed herein are directed to control devices, disk array devices, and control methods.

2. Description of the Related Art

A disk array device sometimes makes an internal configuration redundant to increase the reliability. A disk array system provided with a disk array device and a server may have to operate without stopping. Even when an update (such as an upgrade) of firmware which makes a part of the internal configuration of the disk array device work is performed, the disk array system may have to operate continuously. Updating the firmware without stopping the disk array system is referred to as “a change of firmware without stop”.

As a server realizing a change of firmware without stop in the disk array system, conventionally a disk array system includes a plurality of blade servers, for example. When a BIOS (Basic Input/Output System) of one blade server is updated, the service provided for the blade server is migrated to another blade server, and then the BIOS is updated in a state in which no service is provided for the blade server.

Moreover, as an example of the disk array device, conventionally a disk array system includes a plurality of hard disk devices. When firmware of one hard disk device is updated, data stored in the hard disk device is copied to another hard disk device, and the other hard disk device which is a copy destination is made to carry out input/output processing. While the other hard disk device which is a copy destination is made to carry out input/output processing, the firmware of the hard disk device is updated.

In the disk array device, instead of firmware of the hard disk device, firmware of a Channel Adaptor (CA) performing interface control with the server may be updated.

In this case, the disk array system stops all access to the disk array device from the server by, for example, disabling the use of a connecting path. Thereafter, the firmware of the channel adaptor is installed. After installation of the firmware, the disk array device may be rebooted. The disk array system allows access to the disk array device from the server by, for example, enabling the use of the connecting path, and completes the change of the firmware of the channel adaptor without stop.

There is a disk array system in which a server and a disk array device are connected with two redundant connecting paths. When all of the two connecting paths function normally, a maintenance person stops access from the server to one connecting path, and changes the firmware of the channel adaptor connected to the connecting path while stopping the access. The maintenance person allows access to the connecting path which has been stopped the access, whereby the change of the firmware of the channel adaptor without stop is completed.

A problem of a conventional technique in which a change of firmware of a channel adaptor is without a stop, the channel adaptor performing interface control with the server, is that the operation of the server is affected while the firmware is being updated.

For example, after all access to the disk array device from the server is stopped, the firmware is updated. While the firmware is being updated, all access to the disk array device from the server is stopped. Even when the server tries to perform input/output processing, the server cannot terminate input/output processing normally. This disrupts processing performed by the server.

Moreover, conventionally, the firmware is updated by an operation performed by the maintenance person. For example, due to an error in operation performed by the maintenance person, the firmware may be updated with disabling access to a connecting path via which update of firmware is not performed and enabling access to a connecting path via which update of firmware is performed. This makes it difficult for the disk array device to perform input/output processing from the server during the update of the firmware, resulting in disruption of processing performed by the server.

### SUMMARY

It is an aspect of the embodiments discussed herein to provide a control device and a control method.

The above aspects can be attained by a control device for updating firmware that includes a transfer unit, a judgment unit, a switching control unit and an update unit. The transfer unit transfers data to a first device or a second device by using a path that can switch a transferring destination of data to the first device or the second device. The judgment unit judges whether processing the data by firmware controlling the first device is completed, the data transferred to the first device by the transfer unit. The switching control unit switches the transferring destination of data to the second device in the transfer unit when the judgment unit judges that processing of the data is completed. The update unit updates the firmware controlling the first device after the switching control unit switches the transferring destination of data to the second device in the transfer unit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary disk array device.

FIGS. 2A to 2D illustrate an exemplary firmware change.

FIG. 3 illustrates an exemplary control device.

FIG. 4 illustrates exemplary firmware change processing.

FIG. 5 illustrates an exemplary disk array.

### DETAILED DESCRIPTION OF THE EMBODIMENTS

An exemplary embodiment of a control device, a disk array device, and a control method are described.

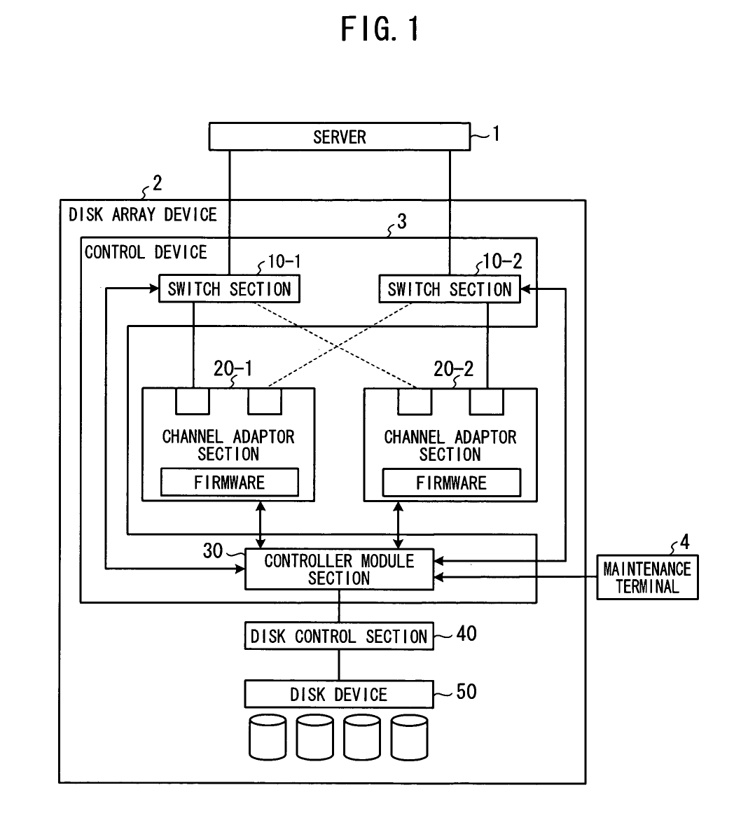

FIG. 1 illustrates an exemplary disk array device. As illustrated in FIG. 1, a disk array device 2 includes a control device 3 having switch sections 10-1 and 10-2 and a controller module section 30, channel adaptor sections 20-1 and 20-2, a disk control section 40, and a disk device 50. In the disk array device 2 in accordance with the embodiment, the switch section 10-1 and the channel adaptor section 20-1 and the switch section 10-2 and the channel adaptor section 20-2 are provided in a redundant configuration. The switch sections 10-1 and 10-2 are connected to a server 1; however, the switch sections 10-1 and 10-2 may be connected to different servers. This exemplary embodiment deals with a multipath configuration in which a plurality of paths are provided between the disk array device 2 and the server 1.

The switch sections 10-1 and 10-2 may be disposed between the server 1 and the channel adaptor sections 20-1 and 20-2, and are connected to the two channel adaptor sections 20-1 and 20-2. For example, the switch section 10-1 mediates exchange of data between the server 1 and the channel adaptor section 20-1 by using previously determined one path (a main path) of two paths connected to the channel adaptor sections 20-1 and 20-2. Moreover, the other path serves as an alternative path of the one path. In an example of FIG. 1, the main path of the switch section 10-1 is connected to the channel adaptor section 20-1, and the alternative path is connected to the channel adaptor section 20-2.

The switch section 10-1 outputs an input/output request from the server 1 to the channel adaptor section 20-1 via the main path. When a change of firmware of the channel adaptor section 20-1 is performed, the switch section 10-1 acquires a request to switch the path from the main path to the alternative path from the controller module section 30. The switch section 10-1 switches the path from the main path to the alternative path. Moreover, after a change of firmware of the channel adaptor section 20-1 is performed, the switch section 10-1 acquires a request to switch the path from the alternative path to the main path from the controller module section 30. The switch section 10-1 switches the path from the main path to the alternative path. In this exemplary embodiment, the input/output request is a write or read request from the server 1 to the disk device 50. The switch section 10-2 similar to switch section 10-1.

The channel adaptor sections 20-1 and 20-2 are internal devices for connecting the disk array device 2 to the server 1, and are connected to the switch sections 10-1 and 10-2 through ports provided therein. The channel adaptor sections 20-1 and 20-2 acquire an input/output request outputted from the server 1 from the switch sections 10-1 and 10-2 via the ports, and output the input/output request to the controller module section 30. The channel adaptor sections 20-1 and 20-2 may be controlled by the firmware held in the channel adaptor sections 20-1 and 20-2. The firmware is updated by the controller module section 30 when, for example, an upgrade is performed or an abnormality is found in the firmware. The channel adaptor section 20-1 and the channel adaptor section 20-2 may map the same LUN (Logical Unit Number) to the disk device 50. Therefore, the channel adaptor section 20-2 may perform the operation of the channel adaptor section 20-1.

The controller module section 30 changes the firmware of the channel adaptor sections 20-1 and 20-2 by controlling switching of the paths of the switch sections 10-1 and 10-2. For example, when the controller module section 30 acquires a request to change the firmware of the channel adaptor section 20-1 from a maintenance terminal 4, the controller module section 30 judges whether processing of all the input/output requests acquired by the channel adaptor section 20-1 before the acquisition of the change request has been completed. If the path is switched to a different alternative path from the main path connected to the channel adaptor section 20-1 in a state in which processing of all the input/output requests acquired by the channel adaptor section 20-1 has not been completed, the processing is disrupted. After processing of all the input/output requests acquired by the channel adaptor section 20-1 is completed, the controller module section 30 changes the firmware of the channel adaptor section 20-1 with new firmware. After completion of a change of the firmware, the controller module section 30 switches the path from the alternative path to the main path. The controller module section 30 switches the path from the alternative path to the main path by performing, with the switch section 10-1, the same processing as that performed when switching the path from the main path to the alternative path. The processing performed by the controller module section 30 may be referred to as “firmware change processing”. The controller module section 30 may perform a change of the firmware of the channel adaptor section 20-2 after acquiring a request to change the firmware of the channel adaptor section 20-2 from the maintenance terminal 4. Furthermore, the controller module section 30 may automatically perform a change of the firmware of the channel adaptor section 20-2 continuously after changing the firmware of the channel adaptor section 20-1. The operation performed when the firmware of the channel adaptor section 20-2 is changed is similar to the operation performed when the firmware of the channel adaptor section 20-1 is changed.

When the controller module section 30 acquires an input/output request from the channel adaptor sections 20-1 and 20-2, the controller module section 30 analyzes the acquired input/output request. When the analysis result is a write request to the disk device 50, the controller module section 30 outputs data to be written to the disk control section 40 along with an address indicating a position in which the data is to be written. On the other hand, when the analysis result is a read request from the disk device 50, the controller module section 30 outputs an address of data to be read to the disk control section 40.

The disk control section 40 is an interface between the controller module section 30 and the disk device 50. For example, when the disk control section 40 acquires data to be written and an address in which the date is to be written from the controller module section 30, the disk control section 40 writes the data in the address on the disk device 50. Moreover, when the disk control section 40 acquires an address of data to be read from the controller module section 30, the disk control section 40 reads the data held in the address from the disk device 50, and outputs the data to the controller module section 30.

The disk device 50 is including a plurality of hard disks, and each hard disk stores data.

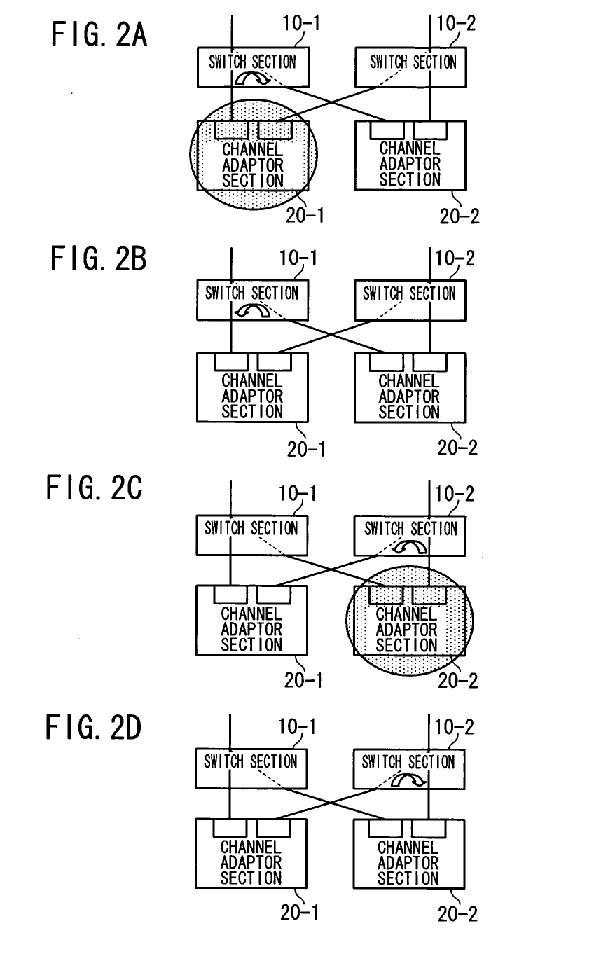

Exemplary “firmware change processing” is illustrated in FIGS. 2A to 2D. The “firmware change processing” may be performed as illustrated in FIG. 2A to FIG. 2D in that order. The firmware of the channel adaptor section 20-1 is changed, and then the firmware of the channel adaptor section 20-2 is changed.

FIG. 2A illustrates that after processing of the input/output request acquired by the channel adaptor section 20-1 is completed, the switch section 10-1 acquires a request to switch the path from the main path to the alternative path from the controller module section 30. The switch section 10-1 switches the path from the main path connected to the channel adaptor section 20-1 to the alternative path connected to the channel adaptor section 20-2. Then, an output of the input/output request to the channel adaptor section 20-1 is stopped, and the controller module section 30 changes the firmware of the channel adaptor section 20-1.

FIG. 2B illustrates that after the firmware of the channel adaptor section 20-1 is changed and processing of the input/output request acquired by the channel adaptor section 20-2 is completed, the switch section 10-1 acquires a request to switch the path from the alternative path to the main path from the controller module section 30. The switch section 10-1 switches the path from the alternative path to the main path. This allows the controller module section 30 to complete the change of the firmware of the channel adaptor section 20-1.

FIG. 2C illustrates that as is the case with the firmware change processing for the channel adaptor section 20-1, the controller module section 30 changes the firmware of the channel adaptor section 20-2. That is, the switch section 10-2 connected with the channel adaptor section 20-2 via the main path acquires a request to switch the path from the main path to the alternative path from the controller module section 30. The switch section 10-2 switches the path from the main path to the alternative path. The controller module section 30 then changes the firmware of the channel adaptor section 20-2.

FIG. 2D illustrates that switch section 10-2 that has acquired a request to switch the path from the alternative path to the main path from the controller module section 30 switches the path from the alternative path to the main path. This allows the controller module section 30 to complete the change of the firmware of the channel adaptor section 20-2.

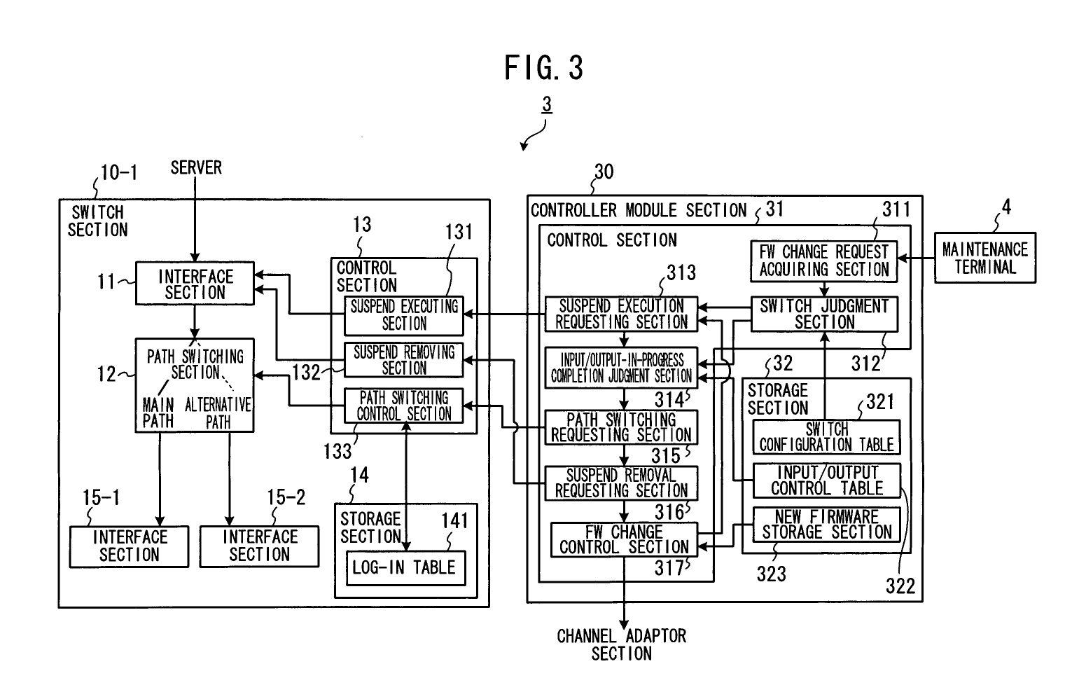

FIG. 3 illustrates an exemplary control device. As illustrated in FIG. 3, the control device 3 includes the switch section 10-1 and the controller module section 30. FIG. 3 illustrates an exemplary case in which the firmware of the channel adaptor section 20-1 is changed. The switch section 10-2 has a similar configuration as the switch section 10-1.

The switch section 10-1 includes an interface section 11, a path switching section 12, a control section 13, a storage section 14, and interface sections 15-1 and 15-2.

The interface section 11 acquires a suspend request from a suspend executing section 131. When the interface section 11 acquires an input/output request from the server 1 after the acquisition of the suspend request, the interface section 11 outputs a busy response indicating that too many input/output requests exist, for example, to the server 1. When the interface section 11 accepts a new input/output request from the server 1, the input/output request may be output to the channel adaptor section 20-1. If the firmware of the channel adaptor section 20-1 is changed in a state in which the input/output request may be output to the channel adaptor section 20-1, processing of the input/output request is disrupted. The busy response may be output to the server 1 in order to prevent processing of the input/output request from being disrupted. Moreover, when the interface section 11 acquires a suspend removal request from a suspend removing section 132, the interface section 11 removes the suspend. When the interface section 11 acquires an input/output request from the server 1 after the removal of the suspending, the interface section 11 outputs the acquired input/output request to the path switching section 12. Suspend may be defined as a suspending the processing.

The path switching section 12 is a switch switching the path to either the alternative path or the main path according to an instruction from a path switching control section 133. When the path switching section 12 acquires an instruction to switch the path from the main path to the alternative path (or from the alternative path to the main path) from the path switching control section 133, the path switching section 12 switches the path from the main path to the alternative path (or from the alternative path to the main path). Moreover, when the path switching section 12 acquires an input/output request from the interface section 11, the path switching section 12 outputs the input/output request to the interface section 15-1 (or the interface section 15-2) corresponding to the path in operation.

The control section 13 includes the suspend executing section 131, the suspend removing section 132, and the path switching control section 133. When the suspend executing section 131 acquires a suspend request from a suspend execution requesting section 313, the suspend executing section 131 outputs the acquired suspend request to the interface section

When the suspend removing section 132 acquires a suspend removal request from a suspend removal requesting section 316, the suspend removing section 132 outputs the acquired suspend removal request to the interface section 11.

When the path switching control section 133 acquires a request to switch the path from the main path to the alternative path (or from the alternative path to the main path) from a path switching requesting section 315, the path switching control section 133 logs out of the channel adaptor section 20-1 (or the channel adaptor section 20-2) connected to the alternative path (or the main path) by using a log-in table 141. The path switching control section 133 logs into the channel adaptor section 20-2 (or the channel adaptor section 20-1) connected to the alternative path (or the main path). Furthermore, when the path switching control section 133 can log into the channel adaptor section 20-2 (or the channel adaptor section 20-1) normally, the path switching control section 133 outputs an instruction to switch the path from the main path to the alternative path (or from the alternative path to the main path) to the path switching section 12. In order to ensure security by, for example, performing authentication of the channel adaptor section 20-2 into which the path switching control section 133 logs, the path switching control section 133 logs out of the channel adaptor section 20-1 connected to the path from which switching is performed and logs into the channel adaptor section 20-2 connected to the path to which switching is performed.

The storage section 14 includes the log-in table 141. The log-in table 141 holds a parameter used when data is transferred between the server 1 and the channel adaptor sections 20-1 and 20-2, for example. In FIG. 3, an identifier of the channel adaptor section 20-1 connected to the main path, the maximum frame length of data to be transferred, and monitoring time are held in one record. Moreover, an identifier of the channel adaptor section 20-2 connected to the alternative path, the maximum frame length of data to be transferred, and monitoring time may be in another record.

When the interface section 15-1 acquires an input/output request from the path switching section 12 while the main path is in operation, the interface section 15-1 outputs the acquired input/output request to the channel adaptor section 20-1.

When the interface section 15-2 acquires an input/output request from the path switching section 12 while the alternative path is in operation, the interface section 15-2 outputs the acquired input/output request to the channel adaptor section 20-2.

The controller module section 30 includes a control section 31 and a storage section 32. The control section 31 includes a firmware (hereinafter referred to as “FW') change request acquiring section 311, a switch judgment section 312, the suspend execution requesting section 313, an input/output-in-progress completion judgment section 314, the path switching requesting section 315, the suspend removal requesting section 316, and a FW change control section 317.

When the FW change request acquiring section 311 acquires a request to change the firmware of the channel adaptor section 20-1 from the maintenance terminal 4, the FW change request acquiring section 311 outputs the acquired identifier of the channel adaptor section 20-1 to the switch judgment section 312.

When the switch judgment section 312 acquires the identifier of the channel adaptor section 20-1 from the FW change request acquiring section 311, the switch judgment section 312 acquires an identifier of the switch corresponding to the identifier of the channel adaptor section 20-1 from a switch configuration table 321. The switch configuration table 321 holds the identifiers of the switch sections 10-1 and 10-2 to which the channel adaptor sections 20-1 and 20-2 are respectively connected as the main path. The switch judgment section 312 outputs the acquired identifier of the switch to the suspend execution requesting section 313 and the input/output-in-progress completion judgment section 314.

When the suspend execution requesting section 313 acquires the identifier of the switch from the switch judgment section 312, the suspend execution requesting section 313 outputs a suspend request to the suspend executing section 131 of the switch section 10-1 corresponding to the acquired identifier of the switch. Moreover, when the suspend execution requesting section 313 acquires notification of the completion of the change of the firmware from the FW change control section 317, the suspend execution requesting section 313 outputs a suspend request to the suspend executing section 131 of the switch section 10-1. After outputting the suspend request, the suspend execution requesting section 313 outputs notification that the suspending is being executed to the input/output-in-progress completion judgment section 314.

The input/output-in-progress completion judgment section 314 acquires the identifier of the switch from the switch judgment section 312. When the input/output-in-progress completion judgment section 314 acquires the notification that the suspend is being executed from the suspend execution requesting section 313, the input/output-in-progress completion judgment section 314 judges whether processing of the input/output request that has been accepted by the channel adaptor section 20-1 before the execution of the suspend is completed. For example, the input/output-in-progress completion judgment section 314 reads, from an input/output control table 322, which will be described later, a processing status of the input/output request that has already been inputted to a port of each of the channel adaptor sections 20-1 and 20-2 connected to the switch section 10-1. The input/output-in-progress completion judgment section 314 judges whether all processing of the input/output request is completed. The input/output control table 322 may hold the processing status of the input/output request inputted to ports incorporated into the channel adaptor sections 20-1 and 20-2 and connected to the switch section 10-1. The ports incorporated into the channel adaptor sections 20-1 and 20-2 connected to the two paths (the main path and the alternative path) of the switch section 10-1 have the same number.

When all processing of the input/output request is not completed, the input/output-in-progress completion judgment section 314 repeats the same judgment processing until all processing of the input/output request is completed. On the other hand, when all processing of the input/output request is completed, the input/output-in-progress completion judgment section 314 outputs notification that all processing of the input/output request has been completed to the path switching requesting section 315.

When the path switching requesting section 315 acquires the notification that all processing of the input/output request has been completed from the input/output-in-progress completion judgment section 314, the path switching requesting section 315 outputs a request to switch the path from the main path to the alternative path (or from the alternative path to the main path) to the path switching control section 133. Thereafter, the path switching requesting section 315 outputs notification that the path has been switched from the main path to the alternative path (or from the alternative path to the main path) to the suspend removal requesting section 316.

When the suspend removal requesting section 316 acquires the notification that the path has been switched from the main path to the alternative path (or from the alternative path to the main path), the suspend removal requesting section 316 outputs a suspend removal request to the suspend removing section 132. Thereafter, when the path has been switched from the main path to the alternative path, the suspend removal requesting section 316 outputs notification that the suspending has been removed to the FW change control section 317. Incidentally, when the path has been switched from the alternative path to the main path, the suspend removal requesting section 316 ends the “firmware change processing” of the channel adaptor section 20-1. This is because the change of the firmware of the channel adaptor section 20-1 has already been completed.

When the FW change control section 317 acquires the notification that the suspend has been removed from the suspend removal requesting section 316, the FW change control section 317 changes the firmware of the channel adaptor section 20-1 connected to the main path. For example, the FW change control section 317 reads new firmware for the channel adaptor section 20-1, the new firmware included in a new firmware storage section 323, from the storage section 32, and uploads it to the channel adaptor section 20-1. The FW change control section 317 installs the uploaded new firmware on the channel adaptor section 20-1. Furthermore, the FW change control section 317 reboots the channel adaptor section 20-1 after installation. The FW change control section 317 outputs notification that the change of the firmware has been completed to the suspend execution requesting section 313.

The storage section 32 includes the switch configuration table 321, the input/output control table 322, and the new firmware storage section 323. The switch configuration table 321 holds a connection configuration of the switch sections 10-1 and 10-2 and the channel adaptor sections 20-1 and 20-2. For example, the switch configuration table 321 holds, in pairs, the identifiers of the channel adaptor sections 20-1 and 20-2 and the identifiers of the switch sections 10-1 and 10-2 to which the channel adaptor sections 20-1 and 20-2 are connected as the main path.

The input/output control table 322 holds the processing status of the input/output request inputted through the port incorporated into each of the channel adaptor sections 20-1 and 20-2 on a port-by-port basis. For example, the input/output control table 322 holds the identifiers of the channel adaptor sections 20-1 and 20-2, a port number, an input/output request number uniquely identifying the input/output request, and a processing state corresponding to the input/output request number on an input/output request number-by-input/output request number basis. The processing states may include, for example, “during execution” indicating that processing of the input/output request is being executed, “on standby” indicating that processing of the input/output request is on standby, and “completion” indicating that processing of the input/output request is completed. A processing status writing section (not shown) may write, into the input/output control table 322, a processing status of the input/output request inputted to each port of the channel adaptor sections 20-1 and 20-2.

The new firmware storage section 323 holds new firmware for the channel adaptor section 20-1 and the channel adaptor section 20-2.

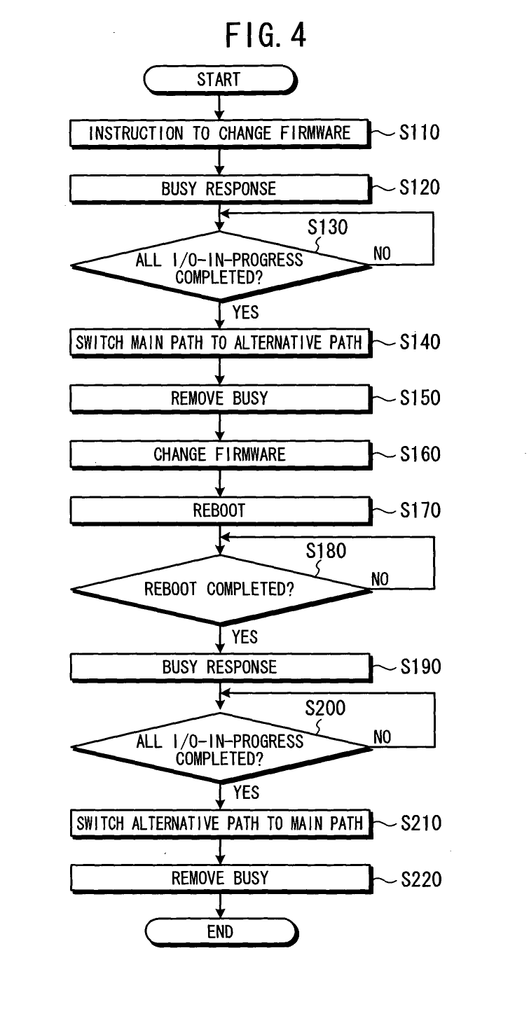

FIG. 4 illustrates an exemplary operation of the firmware change processing. FIG. 4 illustrates processing by which the firmware of the channel adaptor section 20-1 is changed when the switch section 10-1 is connected with the channel adaptor section 20-1 via the main path and is connected with the channel adaptor section 20-2 via the alternative path is described.

The FW change request acquiring section 311 acquires an instruction to change the firmware of the channel adaptor section 20-1 from the maintenance terminal 4 (S110).

The suspend execution requesting section 313 outputs a suspend request to the switch section 10-1 connected with the channel adaptor section 20-1 via the main path, and outputs notification that the suspend is being executed to the input/output-in-progress completion judgment section 314, so that no input/output request is accepted from the server 1 until the main path is switched to the alternative path. The suspend executing section 131 of the switch section 10-1 that has acquired the suspend request suspends the input/output request acquired from the server 1 (S120). For example, the suspend executing section 131 outputs a busy response to the server 1 via the interface section 11 for the input/output request acquired from the server 1.

The input/output-in-progress completion judgment section 314 that has acquired the notification that the suspending is being executed from the suspend execution requesting section 313 judges whether all processing of the input/output request that has been accepted by the channel adaptor section 20-1 before the execution of the suspend is completed (S130).

If the input/output-in-progress completion judgment section 314 judges that all processing of the input/output request is not completed (S130: No), the input/output-in-progress completion judgment section 314 continuously repeats the same judgment processing until all processing of the input/output request is completed.

On the other hand, if the input/output-in-progress completion judgment section 314 judges that all processing of the input/output request is completed (S130: Yes), the path switching requesting section 315 requests the path switching control section 133 of the switch section 10-1 to switch the main path to the alternative path. The path switching control section 133 logs out of the channel adaptor section 20-1 connected to the main path, and logs into the channel adaptor section 20-2 connected to the alternative path, thereby switching the main path of the path switching section 12 to the alternative path (S140).

As a result of the main path being switched to the alternative path, the suspend removal requesting section 316 outputs a suspend removal request to the switch section 10-1, and outputs notification that the suspending has been removed to the FW change control section 317. The suspend removing section 132 of the switch section 10-1 that has acquired the suspend removal request removes the suspend (S150). For example, the suspend removing section 132 removes the busy response to the input/output request acquired from the server 1. While the firmware of the channel adaptor section 20-1 is changed, the channel adaptor section 20-2 processes the input/output request accepted from the server 1 in place of the channel adaptor section 20-1.

The FW change control section 317 that has acquired the notification that the suspending has been removed changes the firmware of the channel adaptor section 20-1 (S160). At this time, the channel adaptor section 20-1 is not processing the input/output request. Then, after changing the firmware, the FW change control section 317 restarts (reboots) the channel adaptor section 20-1 (S170). The FW change control section 317 waits until restarting is completed (S180). After restating is completed (S180: Yes), the FW change control section 317 outputs notification that the change of the firmware has been completed to the suspend execution requesting section 313.

The suspend execution requesting section 313 outputs a suspend request to the suspend executing section 131 of the switch section 10-1 so that no input/output request is accepted from the server 1 until the path is switched from the alternative path to the main path, and outputs notification that the suspend is being executed to the input/output-in-progress completion judgment section 314. The suspend executing section 131 that has acquired the suspend request suspends the input/output request acquired from the server 1 (S190). For example, the suspend executing section 131 outputs, to the server 1 via the interface section 11, a busy response to the input/output request acquired from the server 1.

The input/output-in-progress completion judgment section 314 that has acquired the notification that the suspend is being executed from the suspend execution requesting section 313 judges whether or no all processing of the input/output request that has been accepted by the channel adaptor section 20-2 before the execution of the suspend is completed (S200).

If the input/output-in-progress completion judgment section 314 judges that all processing of the input/output request is not completed (S200: No), the input/output-in-progress completion judgment section 314 continuously repeats the same judgment processing until all processing of the input/output request is completed.

On the other hand, if the input/output-in-progress completion judgment section 314 judges that all processing of the input/output request is completed (S200: Yes), the path switching requesting section 315 requests the path switching control section 133 to switch the alternative path to the main path. The path switching control section 133 logs out of the channel adaptor section 20-2 connected to the alternative path, and logs into the channel adaptor section 20-1 connected to the main path, thereby switching the alternative path of the path switching section 12 to the main path (S210).

After switching from the alternative path to the main path, the suspend removal requesting section 316 outputs a suspend removal request to the suspend removing section 132 of the switch section 10-1. The suspend removing section 132 of the switch section 10-1 that has acquired the suspend removal request removes the suspend (S220). For example, the suspend removing section 132 removes the busy response to the input/output request acquired from the server 1. As a result, the channel adaptor section 20-1 connected with the switch section 10-1 via the main path processes the input/output request accepted from the server 1.

In the exemplary embodiment disclosed above, a multipath configuration in which a plurality of paths are provided between the disk array device 2 and the server 1 has been described; however, the embodiments are not limited thereto. For example, it is also possible to adopt a single-path configuration in which a single path is provided between a disk array device 5 and the server 1.

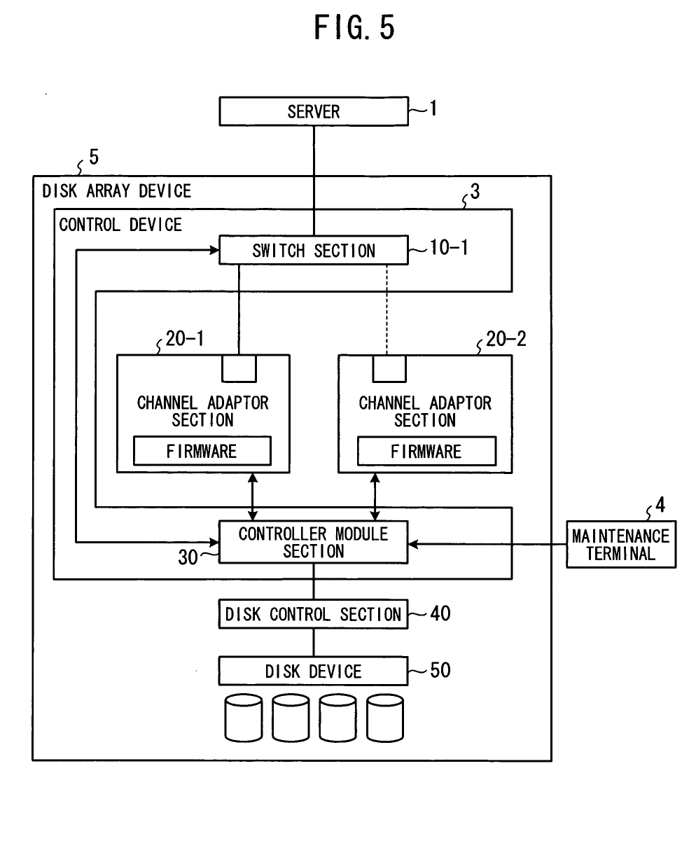

According to an exemplary embodiment, a single-path configuration in which a single path is provided between the disk array device 5 and the server 1 will be described. As illustrated in FIG. 5, the disk array device 5 corresponds to the disk array device 2 (FIG. 1) from which the switch section 10-2 is removed. In FIG. 5 items that are the same as those illustrated in FIG. 1 are identified with the same reference numerals.

Moreover, the operation of the disk array device 5 is similar as that of the disk array device 2.

According to an exemplary embodiment, the switch section 10-1 included in the control device 3 can switch the path to any one of the paths (the main path and the alternative path) connected to the channel adaptor section 20-1 and the channel adaptor section 20-2. Moreover, when the path to which switching is performed is the main path connected to the channel adaptor section 20-1, data is transferred to the channel adaptor section 20-1 by using the main path connected to the channel adaptor section 20-1. Furthermore, the controller module section 30 included in the control device 3 judges whether processing of the transferred data is completed in the channel adaptor section 20-1. Then, if the controller module section 30 judges that processing of the data is completed, the controller module section 30 switches the main path connected to the channel adaptor section 20-1 to the alternative path connected to the channel adaptor section 20-2 by the switch section 10-1. When the main path connected to the channel adaptor section 20-1 is switched to the alternative path connected to the channel adaptor section 20-2 by the switch section 10-1, the controller module section 30 updates the firmware controlling the channel adaptor section 20-1.

After the control device 3 switches the transferring destination from the channel adaptor section 20-1 to the channel adaptor section 20-2, the channel adaptor section 20-2 processes the data in place of the channel adaptor section 20-1. Therefore, it is possible to change the firmware of the channel adaptor section 20-1 without affecting the operation of the server 1 transferring data to the channel adaptor section 20-1 or the channel adaptor section 20-2. Moreover, since the control device 3 automatically changes the firmware of the channel adaptor sections 20-1 and 20-2, it is possible to prevent an error in operation that would occur by the operation performed by a maintenance person.

All or part of the processing performed in the control device 3, the disk array device 2, and the disk array device 5 may be realized by a CPU (Central Processing Unit)(or a microcomputer such as an MPU (Micro Processing Unit) or an MCU (Micro Controller Unit)) and a program analyzed and executed in the CPU (or the microcomputer such as an MPU or an MCU), or may be performed by hardware as wired logic.

According to an exemplary embodiment, when a change is made to the firmware of a lower-level device performing the interface control with a higher-level device, it is possible to change the firmware without affecting the operation of the higher-level device.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A control device for updating firmware, the control device comprising:
a transfer unit that transfers data to a first device or a second device by using a path that can switch a transferring destination of data to the first device or the second device;
a judgment unit that judges whether processing the data by firmware controlling the first device is completed, the data transferred to the first device by the transfer unit;
a switching control unit that switches the transferring destination of data to the second device in the transfer unit when the judgment unit judges that processing of the data is completed; and
an update unit that updates the firmware controlling the first device after the switching control unit switches the transferring destination of data to the second device in the transfer unit.

2. The control device according to claim 1, further comprising:
an acquisition unit that acquires a request to update firmware of the first device from a device other than a higher-level device transferring data to the first device or the second device.

3. The control device according to claim 2, further comprising:
a refusing unit that refuses to receive data transferred from the higher-level device when the request is acquired by the acquisition unit.

4. The control device according to claim 3, wherein
the refusing unit refuses to receive data transferred from the higher-level device by outputting a busy response indicating that too much data exists to the higher-level device.

5. The control device according to claim 3, further comprising:
a refusal removing unit that removes a refusal by the refusing unit to receive data when the switching control unit switching the transferring destination of data to the second device.

6. The control device according to claim 1, wherein
after firmware of the first device is updated by the update unit, the switching control unit switches the transferring destination of data to the first device in the transfer unit.

7. A disk array device having a storage unit which stores data, the disk array device comprising:
first and second devices for processing data which is transferred from a higher level device and is input to the storage unit or output from the storage unit;
a transfer unit for transferring data to the first or second device by using a path that can switch a transferring destination of data to the first or second device;
a judgment unit for judging whether processing the data by firmware controlling the first device is completed, the data transferred to the first device by the transfer unit;
a switching control unit for switching the transferring destination of data to the second device in the transfer unit when the judgment unit judges that processing of the data is completed; and
an update unit for updating the firmware controlling the first device after the switching control unit switches the transferring destination of data to the second device in the transfer unit.

8. A control method for updating firmware, the method comprising:
transferring data to a first device or a second device by using a path that can switch a transferring destination of data to the first or second device;
judging whether processing the data by the firmware controlling the first device is completed;
switching the transferring destination of data to the second device when it is judged that processing of the data is completed; and
updating the firmware controlling the first device after the transferring destination of data is switched to the second device.

9. A control method comprising:
transferring data to a device by using a path that can switch a transferring destination of data;
judging with a microprocessor whether processing the data by firmware controlling the device is completed; and
updating the firmware controlling the device after a transferring destination of data is switched to another device.
